(19) United States
(12) Patent Application Publication
(10) Pub. No.: US 2020/0311672 A1
(43) Pub. Date: Oct. 1, 2020

(54) DELIVERY SYSTEM, MANAGING SERVER, COMPUTER-READABLE STORAGE MEDIUM, AND MANAGEMENT METHOD

(71) Applicant: SoftBank Group Corp., Tokyo (JP)

(72) Inventor: Masayoshi Son, Tokyo (JP)

(21) Appl. No.: 16/596,765

(22) Filed: Oct. 9, 2019

(30) Foreign Application Priority Data
Mar. 29, 2019 (JP) 2019-067358

(51) Int. Cl. G06Q 10/08; H04W 4/40; H04W 4/029; H04W 68/02; H04W 8/22; G06Q 10/10

(52) U.S. Cl. CPC G06Q 10/0838; H04W 4/40; G06Q 10/1097; H04W 68/02; H04W 8/22; H04W 4/029

(57) ABSTRACT

A delivery system is provided, the delivery system including: a superordinate vehicle; a subordinate vehicle; and a managing server that manages package delivery by the superordinate vehicle and the subordinate vehicle, wherein the managing server has: a recipient information acquiring unit that acquires user information about a recipient of the package; a terminal identification information identifying unit that identifies the terminal identification information corresponding to the user information about the recipient by referring to a correspondence data; a positional information acquiring unit that acquires positional information of a mobile communication terminal identified by the terminal identification information from the mobile communication terminal; and a schedule deciding unit that decides a schedule of delivery of the package by the superordinate vehicle and the subordinate vehicle based on the positional information.

The contents of the following Japanese patent application are incorporated herein by reference: 2019-067358 filed in JP on Mar. 29, 2019.

### BACKGROUND

### 1. Technical Field

The present invention relates to a delivery system, a managing server, a computer-readable storage medium, and a management method.

### 2. Related Art

There are known package managing systems to manage packages to be delivered (see Patent Literature 1, for example).

### PRIOR ART LITERATURE

### Patent Literature

[Patent Literature 1] Japanese Patent Application Publication No. 2014-189361

### SUMMARY

It is desirable to provide a technology that can appropriately manage delivery of packages.

### BRIEF DESCRIPTION OF THE DRAWINGS

FIG. 1 schematically illustrates an exemplary delivery system 10.

FIG. 2 schematically illustrates an exemplary flow of processing to be performed by the delivery system 10.

FIG. 3 schematically illustrates an exemplary positional relationship between a user's home 50 and a user 40.

FIG. 4 schematically illustrates an exemplary functional configuration of a managing server 100.

FIG. 5 schematically illustrates an exemplary flow of processing to be performed by the managing server 100.

FIG. 6 schematically illustrates an exemplary functional configuration of a superordinate vehicle 200.

FIG. 7 schematically illustrates an exemplary hardware configuration of a computer 1200 to function as the managing server 100.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

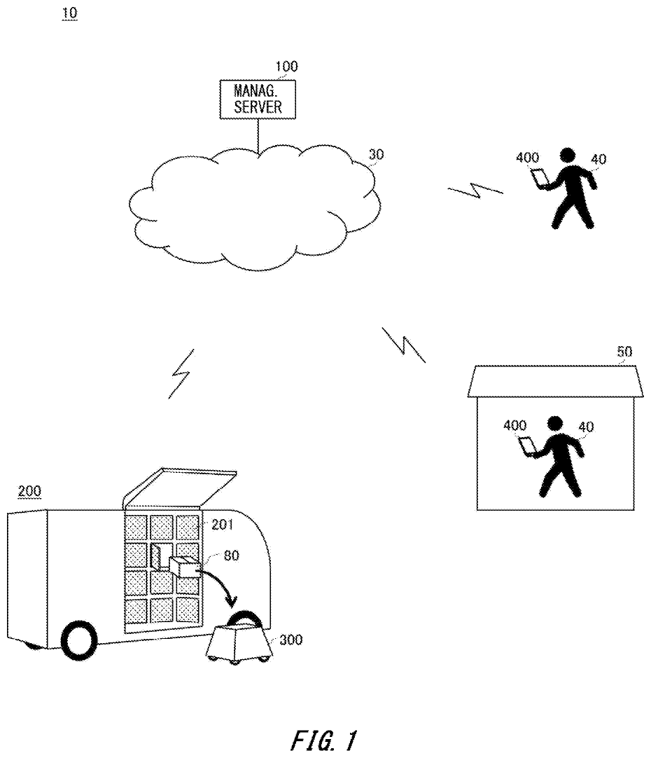

FIG. 1 schematically illustrates an exemplary delivery system 10. The delivery system 10 according to the present embodiment includes a superordinate vehicle 200, a subordinate vehicle 300, and a managing server 100.

The superordinate vehicle 200 can transport a plurality of packages 80. The superordinate vehicle 200 may be an automated driving car. The subordinate vehicle 300 can transport at least one package 80. The subordinate vehicle 300 transports a package 80 received from the superordinate vehicle 200, for example. The subordinate vehicle 300 may be an automated driving car. The number of subordinate vehicles 300 corresponding to the superordinate vehicle 200 may be one or larger than one.

The managing server 100 manages delivery of packages. The managing server 100 may manage delivery of packages 80 by the superordinate vehicle 200 and subordinate vehicles 300.

The managing server 100 and the superordinate vehicle 200 communicate with each other via a network 30. The network 30 may include a cellular communication network and the Internet. The cellular communication network may conform to any of the 3G (3rd Generation) communication standard, LTE (Long Term Evolution) communication standard, 5G (5th Generation) communication standard, or communication standards of and following the 6G (6th Generation) communication standard. The superordinate vehicle 200 may access a cellular communication network via a wireless base station, and may access a cellular communication network via a WiFi (registered trademark) connection.

The managing server 100 and a subordinate vehicle 300 may communicate with each other via the network 30 similar to communication between the managing server 100 and the superordinate vehicle 200. In addition, the managing server 100 and a subordinate vehicle 300 may communicate with each other via the superordinate vehicle 200. The superordinate vehicle 200 and a subordinate vehicle 300 may communicate with each other via the network 30. In addition, the superordinate vehicle 200 and a subordinate vehicle 300 may communicate with each other via a WiFi connection.

The superordinate vehicle 200 has a plurality of housing units 201 each of which can house a package 80, for example. The housing units 201 can house various types of packages 80.

The superordinate vehicle 200 is loaded with packages 80 at any location. The superordinate vehicle 200 is loaded with packages 80 collected by a transport company, for example. In addition, the superordinate vehicle 200 is loaded with packages 80 at a so-called logistics center, for example. In addition, for example, the superordinate vehicle 200 travels to the position of a sender who is to send a package 80, and picks up and is loaded with the package 80. Loading of packages 80 to the superordinate vehicle 200 may be performed manually, and also may be performed by a machine such as a robot.

For example, the superordinate vehicle 200 is loaded with a plurality of packages 80 to be delivered to delivery destinations that are in a certain region, and transports the packages 80 to a certain location in or near the region. A subordinate vehicle 300 may travel to the region along with the superordinate vehicle 200. In addition, the subordinate vehicle 300 may travel to the region separately from the superordinate vehicle 200, and meet the superordinate vehicle 200.

The subordinate vehicle 300 receives a package 80 from the superordinate vehicle 200, and transports it to the delivery destination. Receipt of the package 80 by the subordinate vehicle 300 from the superordinate vehicle 200 may be performed by any method. For example, the package 80 in the superordinate vehicle 200 is passed to the subordinate vehicle 300 manually. In addition, for example, the package 80 is passed from the superordinate vehicle 200 to the subordinate vehicle 300 by a mechanical arm or the like provided to at least any one of the superordinate vehicle 200 and the subordinate vehicle 300.

The managing server 100 manages delivery of packages 80 by the superordinate vehicle 200 and subordinate vehicles 300. The managing server 100 may manage delivery of packages 80 loaded onto the superordinate vehicle 200. The managing server 100 may manage delivery of packages 80 after the packages 80 are loaded onto the superordinate vehicle 200.

In addition, the management by the managing server 100 may start when packages 80 are picked up. For example, if the managing server 100 receives a pick-up request, the managing server 100 instructs the superordinate vehicle 200 to travel to a designated location, and to pick up a package 80. The package may be picked up by the superordinate vehicle 200 or by a subordinate vehicle 300. For example, for a plurality of pick-up requests given from a certain region, the managing server 100 makes the superordinate vehicle 200 travel to a location in or near the region. Then, the managing server 100 or superordinate vehicle 200 instructs a subordinate vehicle 300 to travel to a designated location, and to pick up a package 80. The subordinate vehicle 300 transports the package 80 that it has picked up to the superordinate vehicle 200, and passes it to the superordinate vehicle 200.

The managing server 100 manages user information about a plurality of users 40 registered for delivery services provided by the delivery system 10. The user information includes addresses of the users 40. In addition, the user information includes the names of the users 40. In addition, the user information may include information such as the genders and ages of the users 40.

The managing server 100 may store correspondence data in which the user information about each of the plurality of users 40, and terminal identification information of a mobile communication terminal 400 of the user 40 are associated with each other. The mobile communication terminal 400 is a mobile phone such as a smartphone, for example. The terminal identification information may be any information as long as it allows identification of mobile communication terminals 400.

The users 40 install a dedicated application in mobile communication terminals 400 when registering for delivery services of the delivery system 10, for example. The managing server 100 may cooperate with the application installed in the mobile communication terminals 400 to acquire the user information and terminal identification information from the mobile communication terminals 400.

The managing server 100 manages package information about a plurality of packages 80 loaded onto the superordinate vehicle 200. The package information includes delivery destination information related to the delivery destinations of the packages 80. The delivery destination information includes user information about the recipients of the packages 80. The delivery destination information may include designated delivery time frames. The senders and recipients may be the same persons.

The package information may include content information related to the contents of the packages 80. The content information may include weight information related to the weights of the packages 80. The weight information may be information indicating the weights with numerical values in grams, kilograms, or the like. In addition, the weight information may be information indicating weight-based classification such as heavy, normal, or light. The content information may include size information related to the sizes of the packages 80. The size information may be information indicating the sizes with numerical values in meters, or the like. In addition, the size information may be information indicating size-based classification such as large, normal, or small.

The managing server 100 decides a schedule of delivery of the packages 80 by the superordinate vehicle 200 and subordinate vehicles 300 based on the package information. The managing server 100 decides a delivery schedule including a travel destination of the superordinate vehicle 200, a travel path of the superordinate vehicle 200, travel destinations of subordinate vehicles 300, travel paths of the subordinate vehicles 300, and the like such that the plurality of packages 80 can be delivered in designated delivery time frames included in the delivery destination information.

For each of the plurality of packages 80, the managing server 100 according to the present embodiment acquires the positional information of a mobile communication terminal 400 of the recipient of the package 80, and adjusts the delivery schedule, and/or sends notification data to the recipient. The managing server 100 determines whether or not the user 40 will be able to be at the user's home 50 which is the delivery destination of the package 80 at a scheduled delivery time in the decided delivery schedule at which the package 80 will be delivered to the user's home 50, based on the scheduled delivery time, and the positional information of the mobile communication terminal 400 of the user 40, for example.

If it is determined that the user 40 will be able to be at the user's home 50, the managing server 100 may send notification data including the scheduled delivery time to the mobile communication terminal 400. If it is determined that the user 40 will not be able to be at the user's home 50, the managing server 100 may adjust the delivery schedule. Then, the managing server 100 may send, to the mobile communication terminal 400, notification data including a scheduled delivery time in an adjusted delivery schedule.

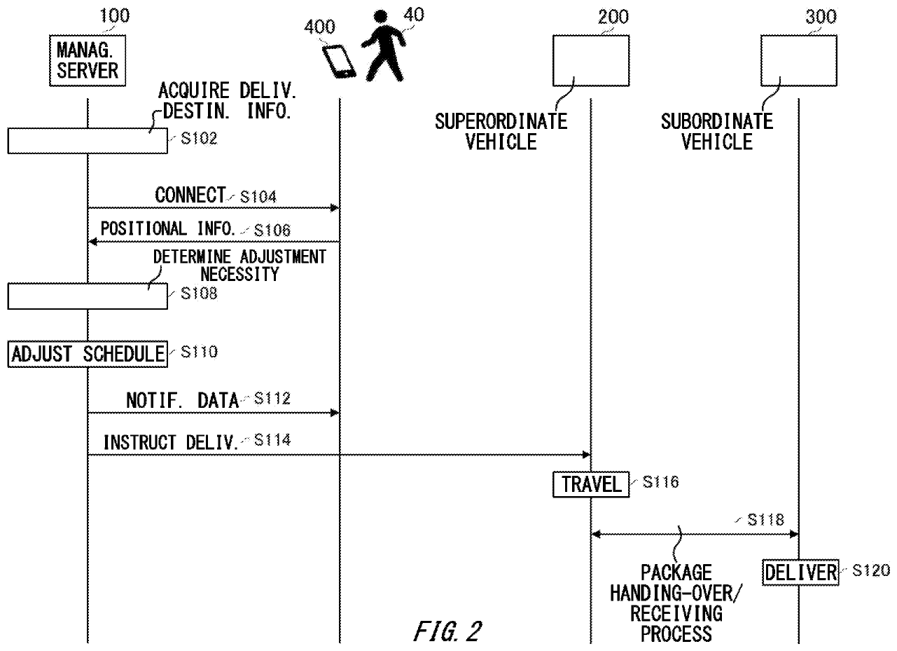

FIG. 2 schematically illustrates an exemplary flow of processing to be performed by the delivery system 10. The management explained here is about the delivery of one package 80 among a plurality of packages 80 after a delivery schedule for the plurality of packages 80 is decided.

At Step 102 (steps are abbreviated to S's in some cases), the managing server 100 acquires delivery destination information of the delivery target package 80. At S104, the managing server 100 identifies terminal identification information corresponding to user information about the recipient included in the delivery destination information, and sends a connection request to a mobile communication terminal 400 identified by the terminal identification information. Based on the connection request, the managing server 100 and the mobile communication terminal 400 establish a connection.

At S106, the mobile communication terminal 400 sends positional information of the mobile communication terminal 400 to the managing server 100. At S108, the managing server 100 determines whether or not it is necessary to adjust the schedule based on the delivery destination address of the package 80, and the position indicated by the positional information received at S106.

For example, the managing server 100 first derives the distance between the delivery destination address of the package 80 and the position indicated by the positional information. Next, the managing server 100 derives required travel time required to travel from the position indicated by the positional information to the delivery destination. Next, the managing server 100 determines whether or not it is necessary to adjust the schedule based on the scheduled delivery time in the delivery schedule, and the required travel time.

For example, the managing server 100 determines that it is necessary to adjust the delivery schedule if the time which is the required travel time after (i) the current time or (ii) a predetermined length of time after the current time is after the scheduled delivery time. For example, the managing server 100 may determine that it is not necessary to adjust the schedule if the time which is the required travel time after (i) the current time or (ii) a predetermined length of time after the current time is before the scheduled delivery time. The predetermined length of time may be set and altered arbitrarily.

Here, the explanation is continued supposing that it is determined that the schedule needs to be adjusted. At S110, the managing server 100 adjusts the delivery schedule. For example, the managing server 100 estimates a length of time required for the user 40, who is the recipient, to travel from the position indicated by the positional information to the delivery destination address to estimate the time at which the user 40 will return to the delivery destination address, and adjusts the delivery schedule such that the package 80 will be delivered after the estimated time.

In addition, for example, the managing server 100 adjusts the delivery schedule such that the location at which the package is passed over and received is altered based on the position indicated by the positional information. For example, if the user 40, who is the recipient, is not near the user's home 50, but at his/her work place, and it is possible to transport the package 80 to the work place or a location near the work place, the delivery schedule is adjusted such that the package 80 is transported to the work place or the location near the work place. At S112, the managing server 100 sends, to the mobile communication terminal 400, notification data including a scheduled delivery time in the schedule adjusted at S110.

At S114, the managing server 100 sends a delivery instruction to the superordinate vehicle 200. At S116, the superordinate vehicle 200 travels according to the delivery instruction received at S114. At S118, a process of passing over and receiving the package 80 is performed between the superordinate vehicle 200 and a subordinate vehicle 300. The superordinate vehicle 200 and the subordinate vehicle 300 may cooperate with each other through a communication to pass over and receive the package 80. At S120, the subordinate vehicle 300 delivers the package 80 received from the superordinate vehicle 200 to the delivery destination.

The configuration as mentioned above in which the positional information of the mobile communication terminal 400 is acquired from the mobile communication terminal 400 of the recipient of the package 80 makes it possible to lower the possibility of inadvertently transporting the package 80 to the delivery destination in the absence of the recipient. In addition, it becomes possible to transport the package 80 to a location which is convenient for the recipient to receive the package 80 if the recipient is to be absent at his/her home.

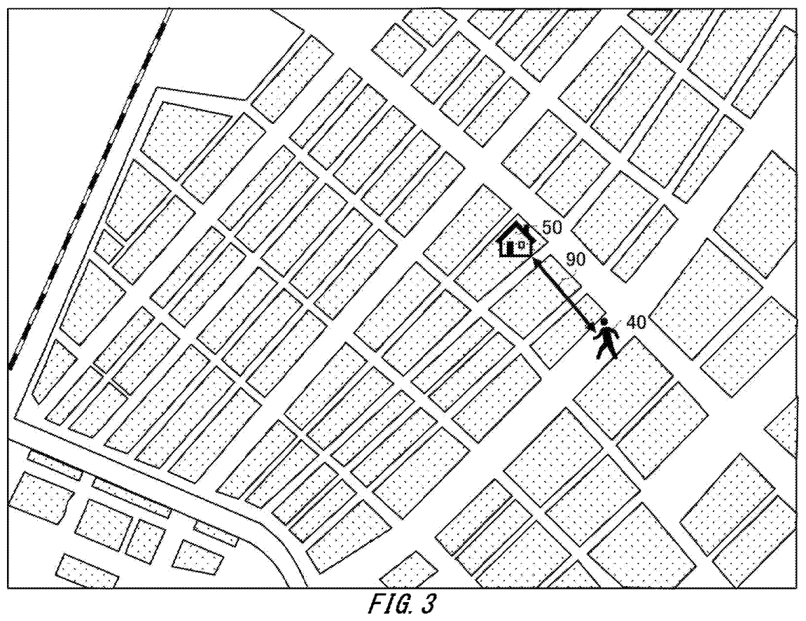

FIG. 3 schematically illustrates an exemplary positional relationship between a user's home 50 which is the delivery destination of a package, and a user 40 who is the recipient of the package. The managing server 100 may adjust a delivery schedule for the package based on a distance 90 between the user's home 50 and the user 40.

The managing server 100 calculates required travel time required for the user 40 to travel to the user's home 50 based on an average travel speed of the user 40 and the distance 90, for example. Then, the managing server 100 performs at least any one of: schedule adjustment; and sending of notification data to a mobile communication terminal 400 of the user 40, based on the positional information of the mobile communication terminal 400 of the user 40, a scheduled delivery time of the package 80 in the delivery schedule, and the calculated required travel time.

For example, if the user 40 is positioned at the user's home 50, which is the delivery destination, the managing server 100 sends, to the mobile communication terminal 400, notification data including the scheduled delivery time in the delivery schedule. In addition, for example, even if the user 40 is not positioned at the user's home 50, which is the delivery destination, the managing server 100 sends, to the mobile communication terminal 400, notification data including the scheduled delivery time in the delivery schedule provided that it is determined that the user 40 will be able to travel to the user's home 50 by the scheduled delivery time.

For example, if it is determined that the user 40 will not be able to travel to the user's home 50 by the scheduled delivery time, the managing server 100 adjusts the delivery schedule. For example, the managing server 100 identifies a time by which the user 40 will be able to travel to the user's home 50, and be positioned at the user's home 50, and adjusts the delivery schedule such that the package 80 is delivered after the identified time.

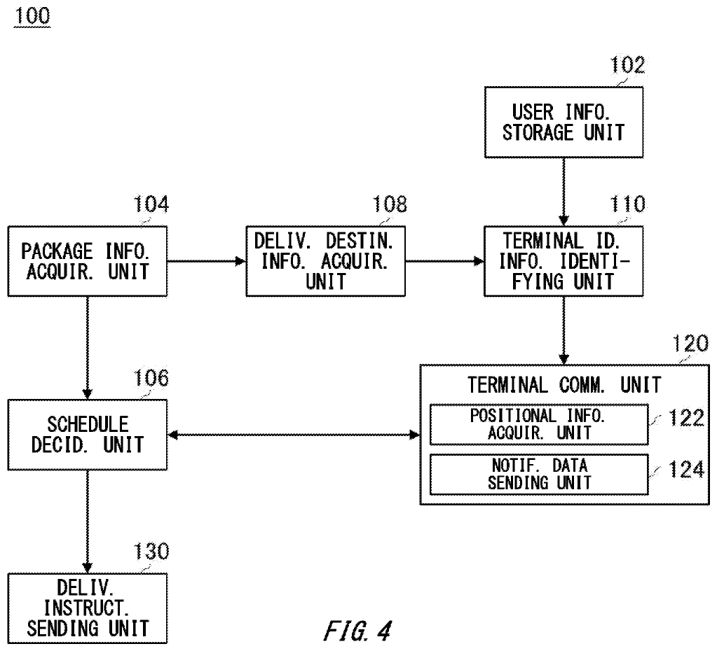

FIG. 4 schematically illustrates an exemplary functional configuration of the managing server 100. The managing server 100 includes a user information storage unit 102, a package information acquiring unit 104, a schedule deciding unit 106, a delivery destination information acquiring unit 108, a terminal identification information acquiring unit 110, a terminal communicating unit 120, and a delivery instruction sending unit 130. Note that the managing server 100 is not necessarily required to include all of these configurations.

The user information storage unit 102 stores user information about a plurality of users 40 registered for delivery services provided by the delivery system 10. The user information storage unit 102 stores correspondence data in which the user information about each of the plurality of users 40, and terminal identification information of a mobile communication terminal 400 of the user 40 are associated with each other. The user information storage unit 102 may be an exemplary correspondence data storage unit.

The package information acquiring unit 104 acquires package information about delivery target packages 80. For example, the package information acquiring unit 104 acquires package information about packages 80 for which a delivery schedule is to be decided, and which are loaded onto the superordinate vehicle 200.

Based on the package information acquired by the package information acquiring unit 104, the schedule deciding unit 106 decides a schedule of delivery of packages by the superordinate vehicle 200 and the subordinate vehicle 300. For example, the schedule deciding unit 106 decides a delivery schedule including a travel destination of the superordinate vehicle 200, a travel path of the superordinate vehicle 200, travel destinations of subordinate vehicles 300, travel paths of the subordinate vehicles 300, and the like such that the plurality of packages 80 can be delivered in designated delivery time frames included in the delivery destination information.

The schedule deciding unit 106 may decide the schedule based further on content information of the packages 80 to be delivered. For example, if the content information includes weight information of a package 80, the schedule deciding unit 106 decides the delivery schedule prioritizing positional information of a mobile communication terminal 400 of a recipient if the weight of the package 80 is lighter than a predetermined first weight, and decides the schedule prioritizing the address of the recipient if the weight of the package 80 is heavier than a predetermined second weight. The second weight may be heavier than the first weight. The second weight may be the same as the first weight.

For example, if the weight of the package 80 is lighter than the first weight, the schedule deciding unit 106 decides the delivery schedule such that the package 80 is delivered to the position indicated by the positional information of the mobile communication terminal 400 of the recipient. In addition, if the weight of the package 80 is heavier than the second weight, the schedule deciding unit 106 decides the delivery schedule such that the package 80 is delivered to the address of the recipient. Thereby, if the delivered package 80 is light, the package 80 can be delivered to a location of the recipient, and if the package 80 is heavy, the package 80 can be delivered to the address of the recipient, thereby improving the convenience for the recipient.

In addition, for example, if the content information includes size information of a package 80, the schedule deciding unit 106 decides the delivery schedule prioritizing positional information of a mobile communication terminal 400 of a recipient if the size of the package 80 is smaller than a predetermined first size, and decides the delivery schedule prioritizing the address of the recipient if the size of the package 80 is larger than a predetermined second size. The second size may be larger than the first size. The second size may be the same as the first size.

For example, if the size of the package 80 is smaller than the first size, the schedule deciding unit 106 decides the delivery schedule such that the package 80 is delivered to the position indicated by the positional information of the mobile communication terminal 400 of the recipient. In addition, if the size of the package 80 is larger than the second size, the schedule deciding unit 106 decides the delivery schedule such that the package 80 is delivered to the address of the recipient. Thereby, if the delivered package 80 is small, the package 80 can be delivered to a location of the recipient, and if the package 80 is large, the package 80 can be delivered to the address of the recipient, thereby improving the convenience for the recipient.

The delivery destination information acquiring unit 108 acquires delivery destination information of a package 80. The delivery destination information acquiring unit 108 may acquire delivery destination information included in package information acquired by the package information acquiring unit 104.

The terminal identification information identifying unit 110 refers to correspondence data stored in the user information storage unit 102 to identify terminal identification information corresponding to user information about a recipient included in delivery destination information acquired by the delivery destination information acquiring unit 108.

The terminal communicating unit 120 communicates with a mobile communication terminal 400 identified by the terminal identification information identified by the terminal identification information acquiring unit 110. The terminal communicating unit 120 may send a connection request to the mobile communication terminal 400 identified by the terminal identification information, and establish a connection with the mobile communication terminal 400.

The terminal communicating unit 120 has a positional information acquiring unit 122 and a notification data sending unit 124. The positional information acquiring unit 122 acquires positional information of a mobile communication terminal 400 sent by the mobile communication terminal 400. The mobile communication terminal 400 may repetitively send the positional information of the mobile communication terminal 400 to the managing server 100, and the positional information acquiring unit 122 may acquire the positional information repetitively sent by the mobile communication terminal 400.

The sending of the positional information by the mobile communication terminal 400 may be executed regularly. In addition, the sending of the positional information by the mobile communication terminal 400 may be executed irregularly. The sending of the positional information by the mobile communication terminal 400 may be executed if a predetermined condition is satisfied. For example, the mobile communication terminal 400 sends the positional information to the managing server 100 if the mobile communication terminal 400 travelled a predetermined distance after it sent the positional information to the managing server 100.

The schedule deciding unit 106 may adjust a decided delivery schedule based on the positional information acquired by the positional information acquiring unit 122. The schedule deciding unit 106 adjusts the delivery schedule based on the positional information acquired by the positional information acquiring unit 122, and the delivery destination address of the package 80, for example.

For example, if a distance between the position indicated by the positional information, and the delivery destination address satisfies a predetermined condition, the schedule deciding unit 106 adjusts the delivery schedule based on the positional information and the delivery destination address. Based on the distance between the position indicated by the positional information, and the delivery destination address, the schedule deciding unit 106 derives travel time required for the recipient of the package 80 to travel from the position indicated by the positional information to the delivery destination address. Based on the travel time, the schedule deciding unit 106 determines whether or not it is possible for the recipient to travel to the delivery destination address by the scheduled delivery time of the package 80 in a decided delivery schedule. If it is determined that the recipient will not be able to travel to the delivery destination address, the schedule deciding unit 106 adjusts the delivery schedule based on the derived travel time. For example, based on the derived travel time, the schedule deciding unit 106 identifies a time by which the recipient will be able to travel to the delivery destination address, and adjusts the delivery schedule such that the package 80 is delivered after the identified time.

The notification data sending unit 124 sends, to the mobile communication terminal 400, notification data based on the positional information of the mobile communication terminal 400 of the recipient of the package 80 and the delivery destination address of the package 80. For example, if the schedule deciding unit 106 adjusted the delivery schedule based on the positional information of the mobile communication terminal 400 of the recipient after the schedule is decided based on the delivery destination address, the notification data sending unit 124 sends, to the mobile communication terminal 400, notification data including a scheduled time of delivery to the delivery destination of the package 80 in the delivery schedule decided based on the delivery destination address if a distance between the position indicated by the positional information of the mobile communication terminal 400 and the delivery destination address is shorter than a predetermined distance. In addition, if the distance between the position indicated by the positional information of the mobile communication terminal 400 and the delivery destination address is longer than the predetermined distance, the notification data sending unit 124 sends, to the mobile communication terminal 400, notification data including a scheduled time of delivery to the delivery destination of the package 80 in the schedule adjusted by the schedule deciding unit 106.

For user information about one user, the user information storage unit 102 may store correspondence data in which the terminal identification information of a mobile communication terminal 400 of the one user and the terminal identification information of a mobile communication terminal 400 of a related user related to the one user are associated with each other. The related user related to the one user may be for example a user who is sharing the home with the one user, and may be for example another family member of the one user's family. The terminal identification information identifying unit 110 may refer to the correspondence data to identify terminal identification information corresponding to user information about the recipient of a package 80, and terminal identification information of a related user related to the recipient.

Then, the schedule deciding unit 106 may decide a delivery schedule based on the positional information of a mobile communication terminal 400 of the recipient, and the positional information of a mobile communication terminal 400 of the related user. For example, if a distance between the position indicated by the positional information of the mobile communication terminal 400 of the recipient and the delivery destination address of the package 80 is longer than a predetermined distance, and a distance between the position indicated by the positional information of the mobile communication terminal 400 of the related user and the delivery destination address of the package 80 is shorter than the predetermined distance, the schedule deciding unit 106 decides a delivery schedule based on the positional information of the mobile communication terminal 400 of the related user.

The delivery instruction sending unit 130 sends, to the superordinate vehicle 200, a delivery instruction for the package 80 that is based on the delivery schedule decided by the schedule deciding unit 106. In addition, the delivery instruction sending unit 130 sends, to the superordinate vehicle 200 a delivery instruction for the package 80 that is based on the delivery schedule adjusted by the schedule deciding unit 106.

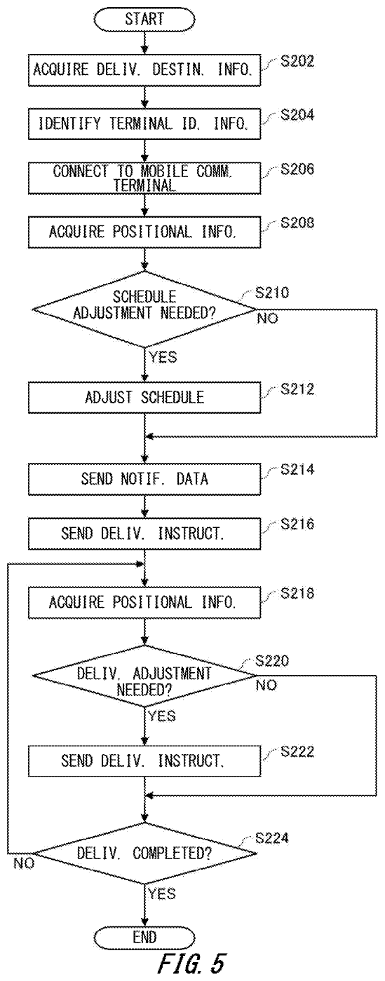

FIG. 5 schematically illustrates an exemplary flow of processing to be performed by the managing server 100. In the flow of processing explained here, after the schedule deciding unit 106 decided a delivery schedule based on package information, the delivery schedule is adjusted based on positional information of a mobile communication terminal 400 of the recipient of a package 80.

At S202, the delivery destination information acquiring unit 108 acquires delivery destination information. At S204, the terminal identification information acquiring unit 110 refers to correspondence data stored in the user information storage unit 102 to identify terminal identification information corresponding to user information included in the delivery destination information acquired by the delivery destination information acquiring unit 108 at S202.

At S206, the terminal communicating unit 120 establishes a connection with a mobile communication terminal 400 identified by the terminal identification information identified at S204. At S208, the positional information acquiring unit 122 acquires positional information of the mobile communication terminal 400 sent by the mobile communication terminal 400.

At S210, the schedule deciding unit 106 determines whether or not it is necessary to adjust the delivery schedule based on the positional information acquired by the positional information acquiring unit 122 at S208, and the delivery destination address of the package 80. If it is determined that it is necessary to adjust the delivery schedule, the process proceeds to S212, and if it is determined that it is not necessary to adjust the delivery schedule, the process proceeds to S214. At S212, the schedule deciding unit 106 adjusts the delivery schedule.

At S214, the notification data sending unit 124 sends notification data to the mobile communication terminal 400. If it is determined at S210 that it is necessary to adjust the schedule, the notification data sending unit 124 sends, to the mobile communication terminal 400, notification data including a scheduled delivery time of the package 80 in a schedule adjusted by the schedule deciding unit 106 at S212. If it is determined at S210 that it is not necessary to adjust the schedule, the notification data sending unit 124 sends, to the mobile communication terminal 400, notification data including a scheduled delivery time of the package 80 in the original decided delivery schedule.

At S216, the delivery instruction sending unit 130 sends a delivery instruction for the package 80 to the superordinate vehicle 200. At S218, the positional information acquiring unit 122 acquires positional information of the mobile communication terminal 400 sent by the mobile communication terminal 400. At S220, the schedule deciding unit 106 determines whether or not it is necessary to adjust the delivery. If it is determined that it is necessary to adjust the delivery, the process proceeds to S222, and if it is determined that it is not necessary to adjust the delivery, the process proceeds to S224. At S222, the schedule deciding unit 106 adjusts the delivery, and the delivery instruction sending unit 130 sends a delivery instruction to the superordinate vehicle 200.

At S224, it is determined whether or not the delivery of the package 80 has been completed. If it is determined that the delivery has not been completed, the process returns to S218, and if it is determined that the delivery has been completed, the management process related to the delivery of the package 80 is ended.

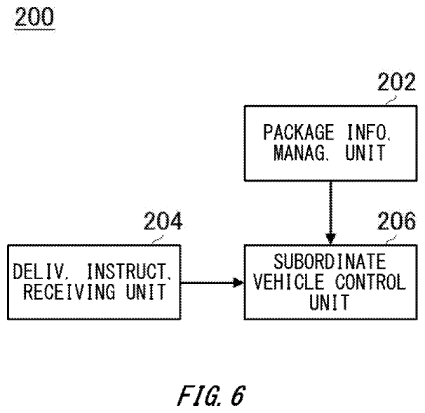

FIG. 6 schematically illustrates an exemplary functional configuration of the superordinate vehicle 200. The superordinate vehicle 200 includes a package information managing unit 202, a delivery instruction receiving unit 204, and a subordinate vehicle control unit 206.

The package information managing unit 202 manages package information about packages 80 housed in the housing units 201 of the superordinate vehicle 200. The delivery instruction receiving unit 204 receives a delivery instruction sent by the managing server 100.

The subordinate vehicle control unit 206 controls one or more subordinate vehicles 300. The subordinate vehicle control unit 206 may control a subordinate vehicle 300 based on a delivery instruction received by the delivery instruction receiving unit 204. For example, based on a signal received from a first subordinate vehicle 300 among the plurality of subordinate vehicles 300, the subordinate vehicle control unit 206 sends a relay instruction instructing a second subordinate vehicle 300 among the plurality of subordinate vehicles 300 to relay a communication between the superordinate vehicle 200 and the first subordinate vehicle 300. If the first subordinate vehicle 300 enters an area where it cannot receive radio waves during transportation of the package 80, for example, it travels to an area where it can receive radio waves, and send signals to the superordinate vehicle 200.

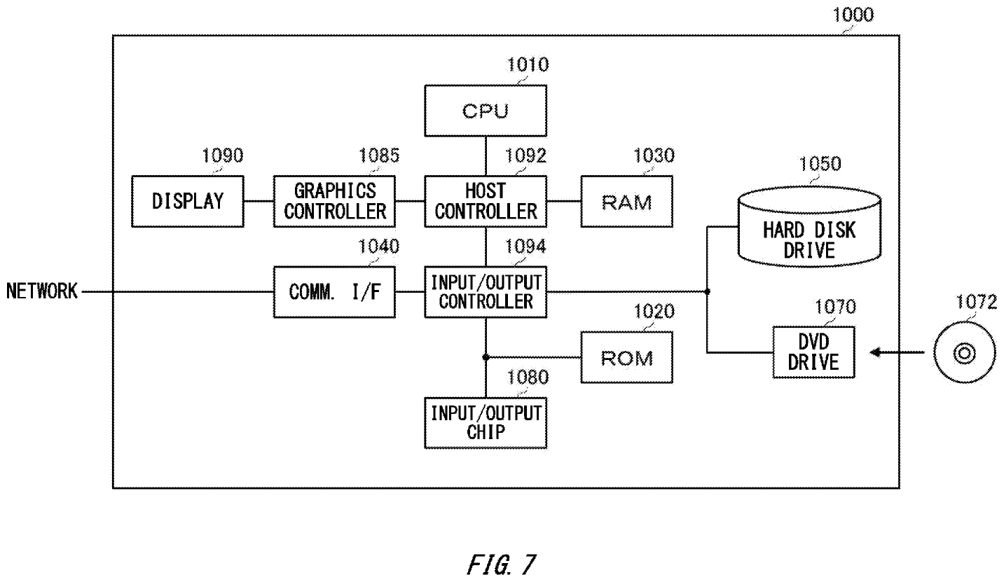

FIG. 7 schematically illustrates an exemplary hardware configuration of a computer 1200 to function as the managing server 100. A program that is installed in the computer 1200 can cause the computer 1200 to function as or perform operations associated with apparatuses of the embodiments of the present invention or one or more sections thereof, and/or cause the computer 1200 to perform processes of the embodiments of the present invention or steps thereof. Such a program may be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, and a graphics controller 1216, which are mutually connected by a host controller 1210. The computer 1200 also includes input/output units such as a communication interface 1222, a storage apparatus 1224, a DVD drive 1226 and an IC card drive, which are connected to the host controller 1210 via an input/output controller 1220. The DVD drive 1226 may be a DVD-ROM drive, a DVD-RAM drive, or the like. The storage apparatus 1224 may be a hard disk drive, a solid state drive, or the like. The computer 1200 also includes legacy input/output units such as a ROM 1230 and a keyboard, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on the display device 1218.

The communication interface 1222 communicates with other electronic devices via a network. The storage apparatus 1224 stores programs and data used by the CPU 1212 within the computer 1200. The DVD drive 1226 reads the programs or the data from the DVD-ROM 1227, and the like, and provides the storage apparatus 1224 with the programs or the data. The IC card drive reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, and the like to the input/output controller 1220.

A program is provided by computer-readable storage media such as the DVD-ROM 1227 or the IC card. The program is read from the computer-readable storage media, installed into the storage apparatus 1224, RAM 1214, or ROM 1230, which are also examples of computer-readable storage media, and executed by the CPU 1212. The information processing described in these programs is read into the computer 1200, resulting in cooperation between a program and the above-mentioned various types of hardware resources. An apparatus or method may be constituted by realizing the operation or processing of information in accordance with the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under control of the CPU 1212, reads transmission data stored on a transmission buffering region provided in a recording medium such as the RAM 1214, the storage apparatus 1224, the DVD-ROM 1227, or the IC card, and transmits the read transmission data to a network or writes reception data received from a network to a reception buffering region or the like provided on the recording medium.

In addition, the CPU 1212 may cause all or a necessary portion of a file or a database to be read into the RAM 1214, the file or the database having been stored in an external recording medium such as the storage apparatus 1224, the DVD drive 1226 (DVD-ROM 1227), the IC card, etc., and perform various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer-readable storage media on or near the computer 1200. In addition, a recording medium such as a hard disk or a RAM provided in a server system connected to a dedicated communication network or the Internet can be used as the computer-readable storage media, thereby providing the program to the computer 1200 via the network.

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable storage media, and/or processors supplied with computer-readable instructions stored on computer-readable storage media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable storage media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable storage media may include an electronic storage medium, a magnetic storage medium, an optical storage medium, an electromagnetic storage medium, a semiconductor storage medium, etc. More specific examples of computer-readable storage media may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE SYMBOLS

10: delivery system; 30: network; 40: user; 50: user's home; 80: package; 90: distance; 100: managing server; 102: user information storage unit; 104: package information acquiring unit; 106: schedule deciding unit; 108: delivery destination information acquiring unit; 110: terminal identification information identifying unit; 120: terminal communicating unit; 122: positional information acquiring unit; 124: notification data sending unit; 130: delivery instruction sending unit; 200: superordinate vehicle; 201: housing unit; 202: package information managing unit; 204: delivery instruction receiving unit; 206: subordinate vehicle control unit; 300: subordinate vehicle; 400: mobile communication terminal; 1200: computer; 1210: host controller; 1212: CPU; 1214: RAM; 1216: graphics controller; 1218: display device; 1220: input/output controller; 1222: communication interface; 1224: storage apparatus; 1226: DVD drive; 1227: DVD-ROM; 1230: ROM; 1240: input/output chip

What is claimed is:

1. A delivery system comprising:
a superordinate vehicle that can transport a plurality of packages;
a subordinate vehicle that can transport a package received from the superordinate vehicle; and
a managing server that manages package delivery by the superordinate vehicle and the subordinate vehicle, wherein
the managing server has:
a correspondence data storage unit that stores correspondence data in which user information about each user among a plurality of users, and terminal identification information of a mobile communication terminal of the user among the plurality of users are associated with each other;
a delivery destination information acquiring unit that acquires delivery destination information related to a delivery destination of a package, the delivery destination information including user information about a recipient of the package;
a terminal identification information identifying unit that identifies the terminal identification information corresponding to the user information about the recipient by referring to the correspondence data;
a positional information acquiring unit that acquires positional information of a mobile communication terminal identified by the terminal identification information from the mobile communication terminal; and
a schedule deciding unit that decides a schedule of delivery of the package by the superordinate vehicle and the subordinate vehicle based on the positional information.

2. The delivery system according to claim 1, wherein
the positional information acquiring unit acquires positional information of the mobile communication terminal repetitively sent by the mobile communication terminal, and
the schedule deciding unit decides the schedule of delivery of the package by the superordinate vehicle and the subordinate vehicle based on the repetitively sent positional information of the mobile communication terminal.

3. The delivery system according to claim 1, wherein the user information includes an address of the user.

4. The delivery system according to claim 3, wherein after deciding the schedule of delivery of the package to the address of the recipient based on the address of the recipient, the schedule deciding unit adjusts the schedule based on the address of the recipient and the positional information acquired by the positional information acquiring unit.

5. The delivery system according to claim 4, wherein the schedule deciding unit adjusts the schedule based on the positional information and the address of the recipient if a distance between a position indicated by the positional information and the address of the recipient satisfies a predetermined condition.

6. The delivery system according to claim 4, wherein the schedule deciding unit:
derives travel time required for the recipient to travel from a position indicated by the positional information to the address of the recipient based on a distance between the position indicated by the positional information and the address of the recipient;
determines, based on the travel time, whether or not the recipient can travel to the address of the recipient by a scheduled delivery time of the package in the schedule decided based on the address of the recipient; and
adjusts the schedule based on the travel time if it is determine that the recipient cannot travel to the address of the recipient by the scheduled delivery time.

7. The delivery system according to claim 3, wherein the schedule deciding unit decides the schedule based further on content information related to a content of the package.

8. The delivery system according to claim 7, wherein the content information includes at least any one of weight information related to a weight of the package, and size information related to a size of the package.

9. The delivery system according to claim 8, wherein
the content information includes the weight information related to the weight of the package, and
the schedule deciding unit:
decides the schedule prioritizing the positional information of the mobile communication terminal of the recipient if the weight of the package is lighter than a predetermined first weight; and
decides the schedule prioritizing the address of the recipient if the weight of the package is heavier than a second weight equal to or heavier than the first weight.

10. The delivery system according to claim 8, wherein
the content information includes the size information related to the size of the package, and
the schedule deciding unit:
decides the schedule prioritizing the positional information of the mobile communication terminal of the recipient if the size of the package is smaller than a predetermined first size; and
decides the schedule prioritizing the address of the recipient if the size of the package is larger than a second size equal to or larger than the first size.

11. The delivery system according to claim 3, wherein the managing server has a notification data sending unit that sends, to the mobile communication terminal of the recipient, notification data which is based on the address of the recipient and the positional information of the mobile communication terminal of the recipient.

12. The delivery system according to claim 11, wherein
after deciding the schedule of delivery of the package to the address of the recipient based on the address of the recipient, the schedule deciding unit adjusts the schedule based on the positional information and the address of the recipient if a distance between the address of the recipient and a position indicated by the positional information of the mobile communication terminal of the recipient satisfies a predetermined condition, and
if the distance between the address of the recipient and the position indicated by the positional information of the mobile communication terminal of the recipient is shorter than a predetermined distance, the notification data sending unit sends, to the mobile communication terminal of the recipient, the notification data including a scheduled time of delivery of the package to the address of the recipient in the schedule decided by the schedule deciding unit based on the address of the recipient.

13. The delivery system according to claim 12, wherein, if the distance between the address of the recipient and the position indicated by the positional information of the mobile communication terminal of the recipient is longer than a predetermined distance, the notification data sending unit sends, to the mobile communication terminal of the recipient, the notification data including a scheduled time of delivery of the package to the address of the recipient in the schedule adjusted by the schedule deciding unit based on the positional information and the address of the recipient.

14. The delivery system according to claim 1, wherein
the correspondence data storage unit stores the correspondence data in which user information about one user is associated with terminal identification information of a mobile communication terminal of the one user, and terminal identification information of a mobile communication terminal of a related user related to the one user, and
the terminal identification information identifying unit identifies the terminal identification information corresponding to the user information about the recipient, and the terminal identification information corresponding to the related user related to the recipient by referring to the correspondence data, and
the schedule deciding unit decides the schedule of delivery of the package by the superordinate vehicle and the subordinate vehicle based on the positional information of the mobile communication terminal of the recipient, and positional information of the mobile communication terminal of the related user.

15. The delivery system according to claim 1, wherein
the managing server has a delivery instruction sending unit that sends, to the superordinate vehicle, a delivery instruction for a package that is based on the schedule decided by the schedule deciding unit,
the superordinate vehicle has:
a delivery instruction receiving unit that receives the delivery instruction; and
a subordinate vehicle control unit that controls a plurality of the subordinate vehicles based on the delivery instruction, and
based on a signal received from a first subordinate vehicle among the plurality of subordinate vehicles, the subordinate vehicle control unit sends a relay instruction to a second subordinate vehicle among the plurality of subordinate vehicles, the relay instruction instructing to relay a communication between the superordinate vehicle and the first subordinate vehicle.

16. A managing server that manages package delivery, the managing server comprising:
a correspondence data storage unit that stores correspondence data in which user information about each user among a plurality of users, and terminal identification information of a mobile communication terminal of the user among the plurality of users are associated with each other;
a delivery destination information acquiring unit that acquires delivery destination information related to a delivery destination of a package, the delivery destination information including user information about a recipient of the package;
a terminal identification information identifying unit that identifies the terminal identification information corresponding to the user information about the recipient by referring to the correspondence data;
a positional information acquiring unit that acquires positional information of a mobile communication terminal identified by the terminal identification information from the mobile communication terminal; and
a schedule deciding unit that decides a schedule of delivery of the package based on the positional information.

17. The managing server according to claim 16, wherein, based on the positional information, the schedule deciding unit adjusts the schedule of delivery of the package by a vehicle to deliver the package.

18. The managing server according to claim 17, wherein, based on the positional information, the schedule deciding unit adjusts the schedule of delivery of the package by a superordinate vehicle that can transport a plurality of packages, and a subordinate vehicle that can transport a package received from the superordinate vehicle.

19. The managing server according to claim 16, comprising a notification data sending unit that sends, to the mobile communication terminal of the recipient, notification data which is based on an address of the recipient and the positional information.

20. A non-transitory computer-readable storage medium having stored thereon a program for making a computer function as:
a correspondence data storage unit that stores correspondence data in which user information about each user among a plurality of users, and terminal identification information of a mobile communication terminal of the user among the plurality of users are associated with each other;
a delivery destination information acquiring unit that acquires delivery destination information related to a delivery destination of a package, the delivery destination information including user information about a recipient of the package;
a terminal identification information identifying unit that identifies the terminal identification information corresponding to the user information about the recipient by referring to the correspondence data;
a positional information acquiring unit that acquires positional information of a mobile communication terminal identified by the terminal identification information from the mobile communication terminal; and
a schedule deciding unit that decides a schedule of delivery of the package based on the positional information.

21. A management method executed by a managing server to manage package delivery, the management method comprising:
acquiring delivery destination information related to a delivery destination of a package, the delivery destination information including user information about a recipient of the package;
identifying terminal identification information corresponding to the user information about the recipient of the package by referring to correspondence data in which user information about each user among a plurality of users, and terminal identification information of a mobile communication terminal of the user among the plurality of users are associated with each other;
acquiring positional information of a mobile communication terminal identified by the terminal identification information from the mobile communication terminal; and
deciding a schedule of delivery of the package based on the positional information.
